(19) United States
(12) Patent Application Publication
(10) Pub. No.: US 2012/0213889 A1
(43) Pub. Date: Aug. 23, 2012

(54) METHODS FOR ENHANCING ANIMAL DIGEST PALATABILITY

(76) Inventor: Wen Chiang, East Lansing, MI (US)

(21) Appl. No.: 13/499,146

(22) PCT Filed: Oct. 8, 2010
(86) PCT No.: PCT/US10/02723

§ 371 Date: May 8, 2012

Related U.S. Application Data
(60) Provisional application No. 61/278,758, filed on Oct. 9, 2009.

(51) Int. Cl. A23J 3/34; G09B 19/00; A47J 36/00; B65D 79/00; A23J 3/04; A23K 1/16

(52) U.S. Cl. 426/57; 426/657; 99/485; 426/87; 434/127

(57) ABSTRACT

The invention provides methods for enhancing the palatability of animal digests by adding anti-gelling agents to animal digests while adjusting the pH to a pH optimal for proteases used to hydrolyze viscera proteins. The anti-gelling agents maximize the production of viscera protein hydrolysates that can participate in Maillard reactions and increase palatability of the animal digest.

### CROSS REFERENCE TO RELATED APPLICATIONS

This application is a national stage application under 35 U.S.C. §371 of PCT/US2010/002723 filed Oct. 8, 2010, which claims priority to U.S. Provisional Application Ser. No. 61/278,758 filed Oct. 09, 2009, the disclosures of which are incorporated herein by this reference.

### BACKGROUND OF THE INVENTION

1. Field of the Invention

The invention relates generally to animal digests and particularly to methods for enhancing the palatability of animal digests.

2. Description of Related Art

Animal digests are materials produced by chemical and/or enzymatic hydrolysis of clean and undecomposed animal tissue. Generally, the animal tissue does not include hair, horns, teeth, hooves, or feathers, except in trace amounts that are unavoidable in normal manufacturing practices. Animal digests are frequently applied to the surface of animal foods to increase palatability, e.g., liquid animal digest applied onto a dry pet food as a palatability enhancer.

Typically, the production of animal digests involves generating a viscera-based protein hydrolysate followed by a Maillard reaction between the proteins produced by the hydrolysis and other compounds in the viscera, e.g., endogenous and exogenous reducing sugars. In this process, the viscera are collected and allowed to digest until endogenous proteases hydrolyze much of the protein. The hydrolyzed protein is then available to participate in Maillard reactions with the reducing sugars. The resulting Maillard reaction products increase the palatability of the digest.

The pH of untreated viscera is typically about 6.0. Unfortunately, many of the endogenous proteases responsible for protein hydrolysis in viscera do not function optimally at this pH. To optimize protein hydrolysis, the pH must be adjusted to a pH that optimizes enzymatic activity, generally from about 7.3 to about 8.5. This pH range is the optimal pH range for trypsin and chymotrypsin activity, the two major proteases in viscera responsible for the majority of protein hydrolysis.

However, adjusting the pH to the optimal range for enzymatic activity causes significant protein gelling in the viscera. The resulting viscous protein gel makes the pH adjustment more difficult, makes handling the viscera more difficult, and decreases the amount of protein hydrolyzed in the viscera in a given time. While the mechanism is uncertain, it appears that gelling inhibits the motion of viscera enzymes, proteins, and other compounds and that the compounds simply cannot interact and engage in chemical reactions as frequently as they would in non-gel environments. Regardless of the mechanism, the gelling results in less hydrolyzed protein and therefore less Maillard reactants to produce the Maillard reaction products that enhance palatability.

Currently, there are no suitable methods to mitigate the problems caused by protein gelling in viscera. There is, therefore, a need for new methods for producing animal digests that minimize the problems caused by protein gelling and increase the palatability of the digests.

### SUMMARY OF THE INVENTION

It is, therefore, an object of the present invention to provide methods for enhancing the palatability of animal digests.

It is another object of the invention to provide animal digests having enhanced palatability.

It is a further object of the invention to provide comestible compositions having enhanced palatability.

It is another object of the invention to provide methods for reducing protein gelling in pH adjusted viscera used to make animal digests.

One or more of these or other objects are achieved using methods that require adding anti-gelling agents to animal digests in conjunction with adjusting the pH to a pH optimal for proteases used to hydrolyze viscera proteins. The anti-gelling agents maximize the production of viscera protein hydrolysates that can participate in Maillard reactions and increase the palatability of the animal digest. The resulting animal digests are mixed with or applied onto comestible ingredients to enhance the palatability of comestible compositions that use animal digest as a palatability enhancer, e.g., pet foods.

Other and further objects, features, and advantages of the present invention will be readily apparent to those skilled in the art.

### DETAILED DESCRIPTION OF THE INVENTION

### Definitions

The term “viscera” means animal tissue useful for producing animal digests.

The term “anti-gelling agent” means any compound, composition, or other material that reduces protein gelling in viscera during the process used to produce animal digests.

The terms “enhanced palatability” and “enhancing palatability” mean that an animal digest or product comprising the animal digest prepared using the anti-gelling agents of the invention is more palatable than an animal digest or product comprising the animal digest prepared without using the anti-gelling agents of the invention.

All percentages expressed herein are by weight of the total weight of the composition unless expressed otherwise.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a digest” or “a method” includes a plurality of such “digests” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides methods for enhancing the palatability of animal digests. The methods comprise:
(1) obtaining animal viscera;
(2) adding an anti-gelling amount of one or more anti-gelling agents to the viscera to produce a viscera mixture;
(3) adjusting the pH of the mixture to from about 7.3 to about 8.5;
(4) permitting the proteases in the mixture to hydrolyze the proteins in the mixture; and
(5) heating the mixture to a temperature that facilitates Maillard reactions.

The invention is based upon the discovery that the proteases in viscera do not function effectively at the typical viscera pH; the pH needs to be adjusted to optimize protease activity and increase protein hydrolysis in the viscera; adjusting the pH causes protein gelling that inhibits protein hydrolysis; anti-gelling agents minimize this protein gelling and therefore increase protein hydrolysis; and an increase in protein hydrolysis increases the concentration of Maillard reactants that produce Maillard reaction products that increase palatability of the digest.

The viscera used in the invention can be obtained from any suitable source. Methods for obtaining viscera, the tissue used for viscera, and the methods for processing viscera to produce animal digest vary depending on the animal and the viscera; such are well known to skilled artisans. Generally, the viscera useful in the invention is viscera from any animal that contains tissue useful for producing animal digest, e.g., the viscera is a poultry, pork, fish, or beef viscera. Typically, viscera include the soft internal organs of the body, especially those contained within the abdominal and thoracic cavities. The tissue and organs used for viscera varies from animal to animal, e.g., “chicken viscera” may include heads and feet. One example of the definition of viscera is given by the Association of American Feed Control Officials, Inc. (AAFCO). AAFCO defines viscera in general as all the organs in the three great cavities of the body (abdominal, thoracic, and pelvic) but defines viscera for fish as all organs in the great cavity of the body, including the gills, heart, liver, spleen, stomach, and intestines. Similarly AAFCO defines viscera for mammals as all organs in the great cavity of the body, including the esophagus, heart, liver, spleen, stomach, and intestines, but excludes the contents of the intestinal tract and defines viscera for poultry as all organs in the great cavity of the body, including the esophagus, heart, liver, spleen, stomach, crop, gizzard, undeveloped eggs, and intestines. Such and similar definitions are known to skilled artisans. In preferred embodiments, the viscera are poultry viscera. In various embodiments, the viscera may be pretreated as known to skilled artisans, e.g., by stirring, homogenizing, emulsifying, and the like.

The anti-gelling agents are added to the viscera using any suitable means or method. Generally, the anti-gelling agents are added to the viscera by pouring the anti-gelling agents into the viscera while the viscera are stirred to ensure an essentially homogenous distribution of the anti-gelling agents in the viscera. Many such methods are known to skilled artisans.

The anti-gelling agents are any compounds, compositions, or other materials that reduce or prevent viscera protein gelling. In one embodiment, the anti-gelling agents are any charged compounds capable of interrupting the electrostatic interactions between proteins, e.g. electrolytes. In another embodiment, the anti-gelling agents are trisodium citrate and sodium sulfate. In other embodiments, the anti-gelling agents are arginine, histidine, and lysine.

In a preferred embodiment, the anti-gelling agents are electrolytes. The electrolytes effectively prevent protein gelling by creating an electrostatic repulsion among the proteins. This repulsion keeps the proteins in a homogenous solution as the pH is adjusted and at the pH used to maximize the protease activity. Using the anti-gelling electrolytes increases the degree of protein hydrolysis, likely because the proteins in solution are more accessible to the proteases than they would be in the gel.

The electrolytes are any electrolytes that reduce or prevent gelling as described herein. In various embodiments, the electrolytes are strong or weak electrolytes that ionize in viscera and are compatible with viscera, e.g., sodium chloride (NaCl), potassium chloride (KCl), tetrasodium pyrophosphate (TSPP), sodium tripolyphosphate (STPP), disodium orthophosphate (DSP), sodium tripolyphosphate (STPP), sodium acid pyrophosphate (SAPP), sodium hexametaphosphate (sodium hexametaphosphate), and combinations thereof. Other electrolytes include ionic compounds such as bromides, fluorides, bisulfates, acetates, borates, citrates, bicarbonates, sodium salts, potassium salts, calcium salts, magnesium salts; copper iodide; and combinations thereof.

In preferred embodiments, the electrolytes are NaCl, TSPP, and combinations thereof.

The anti-gelling agents are added to the viscera in any amount required to minimize protein gelling. In preferred embodiments, the anti-gelling agents are added to the viscera in amounts of from about 0.5 to about 5%, preferably from about 1 to about 4.5%, most preferably from about 1 to about 4%.

In some embodiments, additional water is added to the viscera mixture to ensure that the anti-gelling agents dissolve and remain in solution in the mixture, particularly the electrolytes.

Methods for evaluating gelling in viscera are known to skilled artisans. In some embodiments, the gelling is observed visually. In others, the gelling is measured by determining the difficulty of stirring the viscera, e.g., measuring the shear stress. In others, the viscosity can be measured using a viscometer or the viscoelastic properties can be measured using a rheometer.

The pH can be altered using any method and compound or composition that is capable of affecting the pH of viscera and compatible with viscera. Such compounds or compositions are added in amounts sufficient to achieve the desired pH. Such compounds include sodium hydroxide (NaOH), tris-base, phosphoric acid (H₃PO₄), hydrochloric acid (HCl), sulfuric acid (H₂SO₄), citric acid, and acetic acid. Generally, the compounds are added to the viscera mixture with stirring. In a preferred embodiment, NaOH is added to and thoroughly mixed with the viscera to increase the pH. Methods and techniques for measuring and adjusting pH are known to skilled artisans.

In various embodiments, the pH is adjusted to from about 7.4 to about 8.4, preferably from about 7.6 to about 8.2, most preferably from about 7.8 to about 8.0.

The proteases (endogenous or exogenous) are permitted to hydrolyze viscera proteins using any method known to skilled artisans. In preferred embodiments, the viscera mixture is heated to increase enzyme activity and hydrolysis rate. In one embodiment, the viscera mixture is heated to from about 50° C. to about 75° C. for from about 0.25 to about 4 hours, preferably 0.5 to 2 hours, most preferably 0.5 to 1 hour.

The mixture is heated to any temperature that facilitates Maillard reactions. In various embodiments, the mixture is heated to a temperature of from about 70° C. to about 110° C., preferably from about 80° C. to about 100° C., most preferably 85° C. to about 95°. The mixture is heated using any suitable method, e.g., by direct steam injection, indirect heating via the vessel wall, or indirect steam heating in a jacketed vessel. Other methods are known to skilled artisans, e.g., heat exchangers.

In one embodiment, the methods comprise:
(1) obtaining animal viscera;
(2) adding an anti-gelling amount of one or more anti-gelling agents to the viscera to produce a viscera mixture;
(3) adjusting the pH of the mixture to from about 7.3 to about 8.5;
(4) adjusting the temperature of the mixture to from about 50° C. to about 75° C. and permitting the proteases in the mixture to hydrolyze the proteins in the mixture for from about 0.25 to about 4 hours;
(5) heating the mixture to a temperature of from about 70° C. to about 110° C.

In one embodiment, the methods further comprise adding one or more exogenous proteases to the viscera or the viscera mixture, preferably just before adjusting the pH of the mixture. However, the exogenous proteases can be added at any step in the method before permitting the proteases in the mixture to hydrolyze the proteins in the mixture. Any protease that is compatible with the viscera and that increases protein hydrolysis can be added. The exogenous proteases can be exopeptidases such as aminopeptidases and carboxypeptidases; endopeptidases such as trypsin, chymotrypsin, papain, alcalase, elastase, protemax, neutrase, flavourzyme, and combinations thereof. In a preferred embodiment, the exogenous proteases are trypsin, chymotrypsin, amino-peptidase, carboxy-peptidase, calpain and combinations thereof. In various embodiments, the exogenous proteases are added in amounts of from about 0.01 to about 4%, preferably from about 0.05 to about 0.2%, most preferably from about 0.1 to about 1%. The exogenous proteases are added to the mixture using any suitable method, generally by pouring the proteases into the mixture with stirring.

In one embodiment, the methods further comprise adding one or more reducing sugars to the mixture, preferably just before heating the mixture. However, the reducing sugars can be added at any step in the method before heating. The reducing sugars are any reducing sugars known to skilled artisans to participate in the Maillard reaction and produce Maillard reaction products. Typical reducing sugars include aldoses or ketoses such as glucose, fructose, rhamnose, maltose, lactose, glyceraldehyde, dihydoxyacetone, arabinose, xylose, ribose, mannose, erythrose, threose, galactose, and combinations thereof. The reducing sugars are added in any amount that facilitates desirable Maillard reactions with the proteins and other Maillard reactants in the mixture. In various embodiments, the reducing sugars are added in amounts of from about 0.1 to about 5%, preferably from about 0.5 to about 4%, most preferably from about 1 to about 3%.

In one embodiment, the methods further comprise adding one or more amino acids to the mixture, preferably just before heating the mixture. However, the amino acids can be added at any step in the method before heating. The amino acids are any amino acids known to skilled artisans to participate in the Maillard reaction and produce Maillard reaction products. Typical amino acids include glycine, alanine, cysteine, methionine, proline, and combinations thereof. The amino acids are added in any amount that facilitates desirable Maillard reactions with the reducing sugars and other Maillard reactants in the mixture. In various embodiments, the amino acids are added in amounts of from about 0.1 to about 5%, preferably from about 0.2 to about 3%, most preferably from about 0.3 to about 2%. In one embodiment, the amino acids are added in amounts of from about 0.4 to about 1%.

In a preferred embodiment, the methods further comprise adding one or more reducing sugars and one or more amino acids to the mixture as described herein.

The amount of reducing sugars and amino acids added to the mixture is controlled to prevent excess Maillard reactions that cause excessive browning and other undesirable reactions.

The reducing sugars and amino acids are added to the mixture using any suitable method, generally by pouring the compounds into the mixture with stirring. When both are used, the reducing sugars and amino acids are added individually or are mixed before they are added to the viscera mixture.

In one embodiment, the methods comprise:
(1) obtaining animal viscera;
(2) producing a viscera mixture by adding one or more anti-gelling agents to the viscera in amounts of from about 0.5 to about 5%;
(3) adjusting the pH of the mixture to from about 7.3 to about 8.5;
(4) adding exogenous proteases to the mixture in amounts of from about 0.01 to about 4%;
(5) permitting the endogenous and exogenous proteases in the mixture to hydrolyze the proteins in the mixture; and
(6) heating the mixture to a temperature of from about 70° C. to about 110° C.

In another embodiment, the methods comprise:
(1) obtaining animal viscera;
(2) producing a viscera mixture by adding one or more anti-gelling agents to the viscera in amounts of from about 0.5 to about 5%;
(3) adjusting the pH of the mixture to from about 7.3 to about 8.5;
(4) adding exogenous proteases to the mixture in amounts of from about 0.01 to about 4%;
(5) permitting the endogenous and exogenous proteases in the mixture to hydrolyze the proteins in the mixture;
(6) adding reducing sugars to the mixture in amounts of from about 0.1 to about 5%; and
(7) heating the mixture to a temperature of from about 70° C. to about 110° C.

In a further embodiment, the methods comprise:
(1) obtaining animal viscera;
(2) producing a viscera mixture by adding one or more anti-gelling agents to the viscera in amounts of from about 0.5 to about 5%;
(3) adjusting the pH of the mixture to from about 7.3 to about 8.5;
(4) adding exogenous proteases to the mixture in amounts of from about 0.01 to about 4%;
(5) permitting the endogenous and exogenous proteases in the mixture to hydrolyze the proteins in the mixture;
(6) adding reducing sugars to the mixture in amounts of from about 0.1 to about 5%;
(7) adding amino acids to the mixture in amounts of from about 0.1 to about 5%; and
(8) heating the mixture to a temperature of from about 70° C. to about 110° C.

In one preferred embodiment, the anti-gelling agents are electrolytes as described herein and the exogenous proteases are trypsin, chymotrypsin, and combinations thereof. In such preferred embodiment the electrolytes are NaCl, TSPP, and combinations thereof.

In one embodiment, the methods comprise:
(1) obtaining animal viscera;
(2) producing a viscera mixture by adding one or more anti-gelling agents to the viscera in amounts of from about 0.5 to about 5%;
(3) adjusting the pH of the mixture to from about 7.3 to about 8.5;
(4) permitting the proteases in the mixture to hydrolyze the proteins in the mixture;
(5) adding reducing sugars to the mixture in amounts of from about 0.1 to about 5%;
(6) adding amino acids to the mixture in amounts of from about 0.1 to about 5%; and
(7) heating the mixture to a temperature of from about 70° C. to about 110° C.

In one preferred embodiment, the anti-gelling agents are electrolytes as described herein, preferably NaCl, TSPP, and combinations thereof.

The methods of the invention produce animal digests that have enhanced palatability.

In another aspect, the invention provides animal digests made by the methods of the invention. The digests have enhanced palatability compared to digests made without using the anti-gelling agents.

In another aspect, the invention provides comestible compositions comprising one or more comestible ingredients and one or more animal digests, wherein the animal digests are made by the methods of the invention.

The comestible ingredients are any ingredients suitable for consumption by animals. In one embodiment, the animal digests and comestible ingredients are admixed to produce the composition. In another, the animal digests and one or more comestible ingredients are admixed and subsequently mixed with one or more additional comestible ingredients to produce the composition. In a preferred embodiment, the comestible ingredients are used to produce a food composition and the animal digests are applied to the food composition, e.g., coated onto all or part of the food composition. In a particularly preferred embodiment, the comestible ingredients are used to produce a pet food composition such as a pet food kibble and the animal digests are applied to the pet food composition. In one embodiment, the pet food composition is produced by extrusion. Such ingredients and methods are known to skilled artisans.

The animal digests may be in the form of liquid animal digest or solid animal digest. Solid animal digest, as known to skilled artisans, is prepared by removing the water from liquid animal digest, typically by spray drying to obtain a powder form of the digest.

The comestible compositions with the animal digest of the invention have enhanced palatability.

In another aspect, the invention provides methods for producing a comestible composition having enhanced palatability comprising admixing one or more animal digests and one or more comestible ingredients or applying one or more animal digests to all or part of one or more comestible ingredients, where the animal digests are made using the methods of the invention.

In another aspect, the invention provides methods for reducing protein gelling in pH adjusted viscera used to make animal digests. The methods comprise:
(1) obtaining animal viscera;
(2) producing a viscera mixture by adding one or more anti-gelling agents to the viscera in amounts of from about 0.5 to about 5%; and
(3) adjusting the pH of the mixture to from about 7.3 to about 8.5.

In another aspect, the invention provides the pH adjusted viscera made using the methods of the invention.

In another aspect, the invention provides product manufacturing production lines suitable for producing comestible compositions having enhanced palatability comprising:
(1) one or more devices capable of producing a comestible composition from one or more comestible ingredients;
(2) one or more devices capable of mixing an animal digest with the comestible ingredients or applying an animal digest to all or part of the comestible ingredients; and
(3) one or more animal digests of the invention.

In one embodiment, the devices capable of producing a comestible composition are extruders and related equipment that produce kibbles suitable for use as a pet food composition and the devices capable of mixing an animal digest with the comestible ingredients or applying an animal digest to all or part of the comestible ingredients are coating equipment that applies the animal digest to the surface of the food composition. Such equipment is well known to skilled artisans in the pet food industry.

In another aspect, the invention provides a means for communicating information about or instructions for one or more of (1) methods for making animal digests using the methods of the invention; (2) methods for preventing gelling in pH adjusted animal digests; (3) methods for making comestible compositions of the invention, particularly pet food compositions, (4) methods for reducing or preventing protein gelling in viscera; and (5) contact information for consumers to use if they have a question about the animal digests of the invention or methods for making or using the digests. The means comprise one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

Useful instructions include techniques and step sequences involved in the methods used to make the animal digests; methods for selecting, handling, and using the anti-gelling agents used to prevent gelling in viscera; methods for adjusting the pH; selection of exogenous proteases and methods for using such proteases; methods for selecting and using reducing sugars and amino acids; and methods for producing a Maillard reaction. The communication means is useful for instructing on the benefits of using the present invention and for providing contact information for a consumer or user of the invention to obtain help in using the invention.

In another aspect, the invention provides packages comprising a material suitable for containing animal digests and a label affixed to the packages containing a word or words, picture, design, acronym, slogan, phrase, or other device, or combination thereof, that indicates that the contents of the package contains an animal digest having enhanced palatability made according to the methods of the invention. Typically, such device comprises the words “animal digest having enhanced palatability” or “animal digest formulated using anti-gelling agents” or an equivalent expression printed on the package. Any package or packaging material suitable for containing animal digests is useful in the invention, e.g., a bag, box, bottle, tank car, trucker tank car, can, pouch, and the like manufactured from paper, plastic, foil, metal, and the like. In one embodiment, the packages contain the animal digests of the invention.

In another aspect, the invention provides packages comprising comestible compositions made using the animal digests of the invention and a label affixed to the packages containing a word or words, picture, design, acronym, slogan, phrase, or other device, or combination thereof, that indicates that the contents of the package contains comestible ingredients having enhanced palatability. Typically, such device comprises the words “enhanced palatability” or “food composition having enhanced palatability” or an equivalent expression printed on the package. Any package or packaging material suitable for containing comestible compositions of the invention can be used, e.g., a bag, box, bottle, can, pouch, and the like manufactured from paper, plastic, foil, metal, and the like.

### EXAMPLES

The invention can be further illustrated by the following examples, although it will be understood that these examples are included merely for purposes of illustration and are not intended to limit the scope of the invention unless otherwise specifically indicated.

### Example 1

An animal digest was produced using the ingredients shown in Table 1 and used as a control.

TABLE 1

| | Pounds |
|---|---|
| Chicken Viscera | 120.3 |
| Sodium Hydroxide (50%) | 2.25 |
| Antioxidant | 0.03 |
| Defoamer | 0.09 |
| Phosphoric Acid (75%) | 8.25 |
| Amino Acids | 0.735 |
| Reducing Sugars | 1.23 |
| Potassium Sorbate | 0.28 |
| Process Steam/Water | 16.8 |
| Total | 150 |

To make 150 pounds of the control animal digest, 120.3 pounds of frozen chicken viscera were ground to 3-5 mm piece sizes and added to a Stephan reactor. The reactor was heated to 86° F. (30° C.) by direct steam injection. Antioxidant (0.03 lb) and defoamer (0.09 lb) were added to the reactor. The pH of viscera mixture was adjusted to pH 7.8-8.0 (temperature≈86° F.) with 50% (w/v) NaOH solution. At this point, the viscera mixture became very viscous and gel-like and was very difficult to stir. This viscera mixture was then heated to 158° F. (70° C.) and held at 158° F. for 45 minutes. Dry ingredients (amino acids, reducing sugars, and potassium sorbate) as shown in Table 1 were added to the viscera mixture and the viscera/dry ingredient blend was heated to 200° F. (93.3° C.) and held at 200° F. for 60 minutes to allow Maillard flavor development. The digest was cooled to 110 to 120° F. (43-48° C.) and sieved through a 60 mesh screen. 8.25 pounds of phosphoric acid (75%) was added and mixed to adjust the pH of the digest to pH 2.6.

### Example 2

The procedure in Example 1 was repeated using the ingredients in Table 2, except that the anti-gelling agents sodium chloride and tetrasodium pyrophosphate were dissolved in water and mixed with the viscera prior to the pH adjustment.

TABLE 2

| | Pounds |
|---|---|
| Chicken Viscera | 99.3 |
| Sodium Hydroxide (50%) | 2.24 |
| Antioxidant | 0.03 |
| Defoamer | 0.09 |
| Phosphoric Acid (75%) | 8.25 |
| Amino Acids | 0.735 |
| Reducing Sugars | 1.23 |
| Potassium Sorbate | 0.28 |
| Sodium Chloride | 3.98 |
| Tetrasodium Pyrophosphate | 0.41 |
| Process Steam/Water | 33.5 |
| Total | 150 |

Here to make 150 pounds of the animal digest with anti-gelling agents, 99.3 pounds of frozen chicken viscera were ground to 3-5 mm pieces and added to a Stephan reactor. The reactor was heated to 86° F. (30° C.) by direct steam injection. Antioxidant (0.03 lb) and defoamer (0.09 lb) were added to the reactor. 3.98 pounds of sodium chloride and 0.41 pounds of tetrasodium pyrophosphate were dissolved in 16.8 pounds of water and added to the viscera. The pH of viscera mixture was adjusted to pH 7.8-8.0 (temperature≈86° F.) with 50% (w/v) NaOH solution. Unlike in Example 1, there was no noticeable change in the viscosity and handling of the viscera mixture. This viscera mixture was then heated to 158° F. (70° C.) and held at 158° F. for 45 minutes. Dry ingredients (amino acids, reducing sugars, and potassium sorbate) as shown in Table 2 were added to the viscera mixture and the viscera/dry ingredient blend was heated to 200° F. (93.3° C.) and held at 200° F. for 60 minutes to allow Maillard flavor development. The digest was cooled to 110-120° F. (43-48° C.) and sieved through a 60 mesh screen. 8.25 pounds of Phosphoric acid (75%) was added and mixed to adjust the pH of the digest to pH 2.6.

### Example 3

The procedure in Example 2 was repeated using the ingredients in Table 3, except that 16.8 pounds of water was added and mixed prior to the pH adjustment and the anti-gelling agents were omitted. A significant increase in viscosity and gelling was noticeable on adjusting the pH of the viscera mixture.

TABLE 3

| | Pounds |
|---|---|
| Chicken Viscera | 103.6 |
| Sodium Hydroxide (50%) | 2.24 |
| Antioxidant | 0.03 |
| Defoamer | 0.09 |
| Phosphoric Acid (75%) | 8.25 |
| Amino Acids | 0.735 |
| Reducing Sugars | 1.23 |
| Potassium Sorbate | 0.28 |
| Sodium Chloride | 0 |
| Tetrasodium Pyrophosphate | 0 |
| Process Steam/Water | 33.5 |
| Total | 150 |

### Example 4

The procedure in Example 3 was repeated using the ingredients in Table 4, except after the digest is acidified to pH 2.6, it was spiked with 3.98 pounds of sodium chloride and 0.41 pounds of tetrasodium pyrophosphate. The resulting animal digest did not show a palatability enhancement when compared to the animal digest that had the anti-gelling agents added before protease digestion.

TABLE 4

| | Pounds |
|---|---|
| Chicken Viscera | 99.3 |
| Sodium Hydroxide (50%) | 2.24 |
| Antioxidant | 0.03 |
| Defoamer | 0.09 |
| Phosphoric Acid (75%) | 8.25 |
| Amino Acids | 0.735 |
| Reducing Sugars | 1.23 |
| Potassium Sorbate | 0.28 |
| Process Steam/Water | 33.5 |
| Sodium Chloride | 3.98 |
| Tetrasodium Pyrophosphate | 0.41 |
| Total | 150 |

### Example 5

Raw viscera and the animal digests from Examples 1, 2, and 3 were analyzed for protein molecular weight distribution. Molecular weight distribution was done using Size Exclusion Chromatography. Each sample was extracted in buffered Guanidine Hydrochloride (GuHCl) solution with DL-Dithiothreitol (DTT) for 3 hr at 65° C. with shaking. The size fractions were analyzed using a High Pressure Liquid Chromatograph under the following conditions. The results are shown in Table 5.
Buffered GuHCl solution as mobile phase
2 columns in series and guard column:
TOSOH Biosciences, TSKgel G3000SW_{XL}, 7.8×300 mm, 5μ (Cat. No. M5726-504G)
Eprogen, SynChropak GPCPEP, 7.8×300 mm, 5μ (Cat. No. SPCGPEP-30)
UV detection at 280 nm
Flow Rate: 0.47 mL/min
Run Time: 100 min
Injection Volume: 100

Referring to Table 5, the results show that there was more efficient hydrolysis when the anti-gelling agents were used. There were smaller peptides formed in the presence of the anti-gelling agents than when no anti-gelling agents were used. Clearly, the animal digest made using anti-gelling agents had the greatest shift from larger to smaller molecular weight size ranges.

TABLE 5

| Percent Molecular Weight Ranges (Kilo Daltons) | | | | | | | |
|---|---|---|---|---|---|---|---|
| >30 | 30-25 | 25-20 | 20-15 | 15-10 | 10-5 | 5-2 | Sample ID |
| 14.7% | 2.7% | 3.7% | 4.3% | 5.8% | 8.0% | 9.2% | Raw Viscera |
| 1.8% | 0.8% | 1.3% | 2.0% | 4.3% | 12.4% | 21.4% | Example 1 |
| 0.6% | 0.4% | 0.6% | 1.9% | 6.1% | 17.6% | 28.2% | Example 2 |
| 1.4% | 0.5% | 0.6% | 1.7% | 4.5% | 16.0% | 25.0% | Example 3 |

### Example 6

The animal digests from Examples 1, 2, 3, and 4 were used to coat dry pet food kibbles having the formula shown in Table 6. Coating was done using a drum coater. The kibbles were coated with animal fat followed by animal digest by spraying the fat and digest onto the kibbles while continuously tumbling the kibbles in the drum.

TABLE 6

| Ingredients | Pounds |
|---|---|
| Dry Dog Kibbles | 91 |
| Animal Fat | 7.5 |
| Animal Digest | 1.5 |

Four different coated kibbles were made per the coating formula in Table 6 with each of the four animal digests from Examples 1, 2, 3, and 4, respectively. Same batch of dry dog kibbles was used for all coated kibbles. The kibbles were fed to dogs in a round robin design. i.e., each kibble was tested against the other to compare their relative palatability. For each test, 20 dogs were presented the same amount of each of the two kibbles being tested for twenty minutes. The uneaten kibbles were then weighed to determine the amount consumed. The average consumption of each product was determined and shown in Table 7.

TABLE 7

| Product Coated with Animal Digest | Average Consumption (%) |
|---|---|
| Example 1 | 27.6 |
| Example 2 | 71.7 |
| Example 3 | 53.4 |
| Example 4 | 48 |

Referring to Table 7, the results clearly show that animal digests made with anti-gelling agents have an enhanced palatability. Further, the results show that the enhanced palatability was not due to the anti-gelling agents.

### Example 7

The amount of glucose and xylose in the animal digests from Examples 1 and 2 were determined. Carbohydrates are extracted with water and separated by ion chromatography on an ion exchange column. Electrochemical detection of the eluted compounds is done by a pulsed amperometric detector and quantified by comparison with the peak areas of the carbohydrates in the standard solution. The results are shown in Table 8.

Referring to Table 8, the amount of glucose and xylose in the animal digest made using anti-gelling agents is significantly lower than in the animal digest made without anti-gelling agents. This shows that there were more Maillard reactions consuming the reducing sugars in the digest made using anti-gelling agents. More Maillard reactions mean more Maillard reaction products that enhance the palatability of the digest. As an observation, the digests produced using the invention are darker than digests produced without the invention. This indicates the presence of more Maillard reaction products.

TABLE 8

| Animal Digest Sample | Glucose (ppm) | Xylose (ppm) |
|---|---|---|
| Example 1 | 1780 | 2350 |
| Example 2 | 1540 | 1890 |

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

1. A method for enhancing the palatability of animal digests comprising:
(1) obtaining animal viscera;
(2) adding an anti-gelling amount of one or more anti-gelling agents to the viscera to produce a viscera mixture;
(3) adjusting the pH of the mixture to from about 7.3 to about 8.5;
(4) permitting the proteases in the mixture to hydrolyze the proteins in the mixture; and
(5) heating the mixture to a temperature that facilitates Maillard reactions.

2. The method of claim 1 wherein the anti-gelling agents are charged compounds capable of interrupting the electrostatic interactions between proteins.

3. The method of claim 1 wherein the anti-gelling agents are electrolytes.

4. The method of claim 3 wherein the anti-gelling agents are sodium chloride (NaCl), potassium chloride (KCl), tetrasodium pyrophosphate (TSPP), sodium tripolyphosphate (STPP), disodium orthophosphate (DSP), sodium tripolyphosphate (STPP), sodium acid pyrophosphate (SAPP), sodium hexametaphosphate (sodium hexametaphosphate), and combinations thereof.

5. The method of claim 3 wherein the anti-gelling agents are bromides, fluorides, bisulfates, acetates, borates, citrates, bicarbonates, sodium salts, potassium salts, calcium salts, magnesium salts, copper iodide, and combinations thereof.

6. The method of claim 1 wherein the anti-gelling agents are sodium chloride, tetrasodium pyrophosphate, and combinations thereof.

7. The method of claim 1 wherein the anti-gelling agents are added in amounts of from about 0.5 to about 5%.

8. The method of claim 1 wherein the pH is adjusted to from about 7.4 to about 8.4.

9. The method of claim 1 wherein the pH is adjusted to from about 7.6 to about 8.2.

10. (canceled)

11. The method of claim 1 wherein the proteases are permitted to hydrolyze the proteins in the mixture at a temperature of from about 50° C. to about 75° C. for from about 0.25 to about 4 hours.

12. The method of claim 1 wherein the mixture is heated to a temperature of from about 70° C. to about 110° C. to facilitate Maillard reactions.

13. The method of claim 1 further comprising adding one or more exogenous proteases to the viscera or the viscera mixture before permitting the proteases in the mixture to hydrolyze the proteins in the mixture.

14. (canceled)

15. (canceled)

16. (canceled)

17. (canceled)

18. The method of claim 1 further comprising adding one or more reducing sugars to the mixture before heating.

19. The method of claim 1 further comprising adding one or more amino acids to the mixture before heating.

20. The method of claim 1 further comprising adding one or more reducing sugars and one or more amino acids to the mixture before heating.

21. The method of claim 1 further comprising adding one or more exogenous proteases to the viscera or the viscera mixture before permitting the proteases in the mixture to hydrolyze the proteins in the mixture, and adding one or more reducing sugars and one or more amino acids to the mixture before heating.

22. The animal digests made by the method of claim 1.

23. A comestible composition comprising one or more comestible ingredients and one or more animal digests, wherein the animal digests are made by the method of claim 1.

24. The comestible composition of claim 23 wherein the composition is a pet food composition.

25. A method for producing a comestible composition having enhanced palatability comprising admixing one or more animal digests and one or more comestible ingredients or applying one or more animal digests to all or part of one or more comestible ingredients, where the animal digests are made using the methods of claim 1.

26. (canceled)

27. (canceled)

28. (canceled)

29. (canceled)

30. (canceled)

31. (canceled)

32. (canceled)
